(19) United States
(12) Patent Application Publication
(10) Pub. No.: US 2024/0095062 A1
(43) Pub. Date: Mar. 21, 2024

(54) OFFLOADED TASK COMPUTATION ON NETWORK-ATTACHED CO-PROCESSORS

(71) Applicant: NVIDIA Corporation, Santa Clara, CA (US)

(72) Inventors: Sourav Chakraborty, Austin, TX (US); Tomislav Janjusic, Parker, TX (US); Mohammadreza Bayatpour, Campbell, CA (US); Joshua Samuel Ladd, Knoxville, TN (US)

(21) Appl. No.: 17/949,817

(22) Filed: Sep. 21, 2022

(51) Int. Cl. G06F 9/48; G06F 9/445; G06F 12/1081

(52) U.S. Cl. CPC G06F 9/4806; G06F 9/44594; G06F 12/1081

(57) ABSTRACT

Systems, methods, and devices for performing computing operations are provided. In one example, a device is described to include a first processing unit and second processing unit in communication via a network interconnect. The first processing unit is configured to offload at least one of computation tasks and communication tasks to the second processing unit while the first processing unit performs the application-level processing tasks. The second processing unit is also configured to provide a result vector to the first processing unit when the at least one of computation tasks and communication tasks are completed.

### FIELD OF THE DISCLOSURE

The present disclosure is generally directed toward networking and, in particular, toward advanced computing techniques employing distributed processes.

### BACKGROUND

Distributed communication algorithms, such as collective operations, distribute work amongst a group of communication endpoints, such as processes. A collective operation is where each instance of an application on a set of machines needs to transfer data or synchronize (communicate) with its peers. Each collective operation can provide zero or more memory locations to be used as input and output buffers.

Reduction is an operation where a mathematical operation (e.g., min, max, sum, etc.) is applied on a set of elements. In an Allreduce collective operation, for example, each application process contributes a vector with the same number of elements and the result is the vector obtained by applying the specified operation on elements of the input vectors. The resultant vector has the same number of elements as the input and needs to be made available at all the application processes at a specified memory location.

### BRIEF SUMMARY

A cluster is a collection of machines connected using an interconnect. Each machine has one or more processors (e.g., a Central Processing Unit (CPU)) and one or more network-attached co-processors (e.g., a Data Processing Unit (DPU)). The DPUs can use different architectures and operating systems as compared to the CPUs. The CPUs and DPUs can include one or more compute cores and can run more than one process simultaneously. The CPUs and DPUs may be configured to transfer data to each other.

Parallel applications can be executed on a set of machines in the cluster. A new approach is proposed to perform a collective operation (e.g., an Allreduce collective) on a cluster of machines equipped with network-attached co-processors (e.g., DPUs). Offloading portions of a collective operation to a network-attached co-processor allows the application to offload the necessary computation and communication to the co-processor and free up the primary processor (e.g., CPU) for the application itself. Previous solutions were applicable to machines without DPUs and hence are not applicable in this scenario.

Message Passing Interface (MPI) is a communication protocol that is used to exchange messages among processes in high-performance computing (HPC) systems. MPI, among other communication protocols, supports collective communication in accordance with a message-passing parallel programming model, in which data is moved from the address space of one process to that of another process through cooperative operations on each process in a process group. MPI provides point-to-point and collective operations that can be used by applications. These operations are associated with a defined object called a communicator. Communicators provide a mechanism to construct distinct communication spaces in which process groups can operate. Each process group is associated with a communicator and has a communicator identifier that is unique with respect to all processes inside the communicator. While embodiments of the present disclosure will be described with respect to MPI, it should be appreciated that MPI is one of many communication protocols that can be used to exchange data between distributed processes. Having all processes participating in a distributed algorithm be provided with a consistent view of group activity in the operation supports the use of adaptive algorithms.

Modern computing and storage infrastructure use distributed systems to increase scalability and performance. Common uses for such distributed systems include: datacenter applications, distributed storage systems, and HPC clusters running parallel applications While HPC and datacenter applications use different methods to implement distributed systems, both perform parallel computation on a large number of networked compute nodes with aggregation of partial results or from the nodes into a global result. Many datacenter applications such as search and query processing, deep learning, graph and stream processing typically follow a partition-aggregation pattern.

Typically, HPC systems contain thousands of nodes, each having tens of cores. When launching an MPI job, the user specifies the number of processes to allocate for the job. These processes are distributed among the different nodes in the system. The MPI standard defines blocking and non-blocking forms of barrier synchronization, broadcast, gather, scatter, gather-to-all, all-to-all gather/scatter, reduction, reduce-scatter, and scan. A single operation type, such as Allreduce, may have several different variants, such as blocking and non-blocking Allreduce. These collective operations scatter or gather data from all members to all members of a process group.

The host (e.g., CPU) and the DPU may be connected to each other through a Remote Direct Memory Access (RDMA)-capable Network Interface Controller (NIC). The CPU and DPU memory may be registered with the NIC before being used in communication. During initialization, the host (e.g., CPU) and the DPU may exchange a set of memory addresses and associated keys for sending and receiving control messages. The execution of an Allreduce collective consists of the following phases: initialization phase; get+reduce phase; and broadcast phase.

In the initialization phase, the host (e.g., CPU) sends a control message with the initialization information (e.g., type of reduction operation, number of elements, addresses of the input, and/or output vectors) to the DPU. In some embodiments, once the control message has been sent, the host (e.g., CPU) can perform application computation or periodically poll a pre-determined memory location to check for a completion message from the DPU. Each instance of the application may be identified by an integer (e.g., logical rank) ranging from 0 to N−1 where N is the number of instances. The input vector may be divided into N chunks and each chunk can be assigned to a DPU according to its identifier rank.

In the get+reduce phase, each DPU may receive the control message and initiate the Allreduce collective independent of each other. In some embodiments, each DPU pre-allocates at least three buffers in its memory identified as the accumulate buffer and two get buffers. Using the RDMA capability of the NIC, the DPU can read the input vector from its own host into the accumulate buffer. The accumulate and get buffers may not be large enough to hold all the elements of the input vectors assigned to a DPU. In this case only the number of elements that can fit in the buffer are copied at a time. The DPU may track of the number of elements read and the offset for subsequent reads.

In some embodiments, each DPU then issues an RDMA read from the input vector of the next logical host into its first get buffer. Once the data is available in the first get buffer, a reduction operation is initiated on the accumulate buffer and the first get buffer and the result is stored in the accumulate buffer. This reduction can be performed in parallel on multiple cores of the DPU. While the reduction is in progress, the DPU can issue another RDMA read from the input vector of the next logical host into the second get buffer. Once the reduction and read operations have been completed, the DPU can initiate another reduction from the accumulate buffer and the second get buffer into the accumulate buffer. The first get buffer is now unused and another RDMA read is issued into the first get buffer for the next logical host. This process of alternating the get buffers may be continued until the DPU has received and reduced the assigned elements from each of the participant hosts (e.g., CPUs).

In the broadcast phase, the result of the reduction is available in the accumulate buffer. In some embodiments, each DPU holds a portion of the output vector. Each DPU may perform an RDMA write to the address of the output vector at each participant host at the corresponding offset. Once the entire result vector has been broadcasted to the host memory, the DPUs can synchronize with one another to ensure that all the participant DPUs have finished broadcasting their respective results. At this point, the DPUs may send a message to their host to signal the completion of the Allreduce collective and the application can proceed.

Embodiments of the present disclosure aim to improve the overall efficiency and speed with which collective operations, such as Allreduce, are performed by offloading various tasks (e.g., computation and/or communication tasks). Offloading certain tasks of a collective operation may allow the primary processor (e.g., CPU) to complete other types of tasks, such as application-level tasks, in parallel with the DPU(s) performing the computation and/or communication tasks. Advantages offered by embodiments of the present disclosure include, without limitation: (1) use of network-attached co-processor for the reduction and data transfer; (2) use of multiple buffers and RDMA to overlap computation and communication; (3) allows reduction of arbitrarily large vectors with limited DPU memory; and (4) support multiple co-processors per machine.

Illustratively, and without limitation, a device is disclosed herein to include: a network interconnect; a first processing unit that performs application-level processing tasks; and a second processing unit in communication with the first processing unit via the network interconnect, where the first processing unit offloads at least one of computation tasks and communication tasks to the second processing unit while the first processing unit performs the application-level processing tasks, and where the second processing unit provides a result vector to the first processing unit when the at least one of computation tasks and communication tasks are completed.

In some embodiments, the network interconnect includes a Remote Direct Memory Access (RDMA)-capable Network Interface Controller (NIC) and the first processing unit and second processing unit communicate with one another using RDMA capabilities of the RDMA-capable NIC.

In some embodiments, the first processing unit includes a primary processor and the second processing unit includes a network-attached co-processor.

In some embodiments, the primary processor includes a Central Processing Unit (CPU) that utilizes a CPU memory as part of performing the application-level processing tasks and the network-attached co-processor includes a Data Processing Unit (DPU) that utilizes a DPU memory as part of performing the at least one of computation tasks and communications tasks.

In some embodiments, the DPU receives a control message from the CPU and in response thereto allocates at least one buffer from the DPU memory to perform the at least one of computation tasks and communication tasks.

In some embodiments, the DPU performs the at least one of computation tasks and communication tasks as part of an Allreduce collective.

In some embodiments, the CPU memory and the DPU memory are registered with the network interconnect before communications between the CPU and DPU are enabled via the network interconnect.

In some embodiments, the CPU and the DPU exchange a set of memory addresses and associated keys for sending and receiving control messages via the network interconnect.

In some embodiments, the first processing unit sends a control message to the second processing unit to initialize the second processing unit and initiate a reduction operation, where the control message identifies at least one of a type of reduction operation, a number of elements, an address of an input vector, and an address of an output vector.

In some embodiments, the first processing unit periodically polls a predetermined memory location to check for a completion message from the second processing unit.

In some embodiments, the second processing unit computes a result of at least a portion of a reduction operation, maintains the result in an accumulate buffer, and broadcasts the result to the first processing unit.

In some embodiments, the second processing unit broadcasts the result to a processing unit of another device in addition to broadcasting the result to the first processing unit.

In some embodiments, the application-level processing tasks and the at least one of computation tasks and communication tasks are performed as part of an Allreduce collective operation.

A system is also disclosed that includes: an endpoint that belongs to a collective, where the endpoint performs application-level tasks for a collective operation in parallel with one or both of computation tasks and communication tasks for the collective operation.

In some embodiments, the collective operation includes an Allreduce collective, where the application-level tasks are performed on a first processing unit of the endpoint, and where the one or both of computation tasks and communication tasks are offloaded by the first processing unit to a second processing unit of the endpoint.

In some embodiments, the first processing unit is network connected to the second processing unit, where the first processing unit utilizes a first memory device of the endpoint, and where the second processing unit utilizes a second memory device of the endpoint.

In some embodiments, the first processing unit communicates with the second processing unit using a Remote Direct Memory Access (RDMA)-capable Network Interface Controller (NIC).

In some embodiments, the system further includes a second endpoint that also belongs to the collective, where the second endpoint also performs application-level tasks for the collective operation in parallel with one or both of computation tasks and communication tasks for the collective operation.

An endpoint is also disclosed that includes: a host; and a Data Processing Unit (DPU) that is network-connected with the host, where the DPU includes a DPU daemon that coordinates a collective offload with the host through a network interconnect and services a collective operation on behalf of the host.

In some embodiments, the DPU daemon assumes full control over the collective operation after receiving an initialization signal from the host.

In some embodiments, the DPU daemon broadcasts results of the collective operation to the host and to hosts of other endpoints belonging to a collective.

In some embodiments, the collective operation includes at least one of Allreduce, Iallreduce, Alltoall, Ialltoall, Alltoallv, Ialltoallv, Allgather, Scatter, Reduce, and Broadcast.

Additional features and advantages are described herein and will be apparent from the following Description and the figures.

### BRIEF DESCRIPTION OF THE SEVERAL VIEWS OF THE DRAWINGS

The present disclosure is described in conjunction with the appended figures, which are not necessarily drawn to scale:

FIG. 1A is a block diagram illustrating a computing system in accordance with at least some embodiments of the present disclosure;

FIG. 1B is a block diagram illustrating one possible communication approach used by the computing system of FIG. 1A;

FIG. 1C is a block diagram illustrating another possible communication approach used by the computing system of FIG. 1A;

FIG. 1D is a block diagram illustrating another possible communication approach used by the computing system of FIG. 1A;

FIG. 2 is a block diagram illustrating details of machines or devices used in a collective operation in accordance with at least some embodiments of the present disclosure;

FIG. 3A illustrates details of an accumulate and get process performed in accordance with at least some embodiments of the present disclosure;

FIG. 3B illustrates details of an accumulate or broadcast process performed in accordance with at least some embodiments of the present disclosure;

FIG. 4 is a block diagram illustrating details of a node used in a collective operation in accordance with at least some embodiments of the present disclosure;

FIG. 5 is a flow diagram illustrating details of an initialization phase in accordance with at least some embodiments of the present disclosure;

FIG. 6 is a flow diagram illustrating additional processes that may be performed by a co-processor in accordance with at least some embodiments of the present disclosure;

FIG. 7 is a flow diagram illustrating details of a buffer registration process in accordance with at least some embodiments of the present disclosure;

FIG. 8 is a flow diagram illustrating details of a collective operation in accordance with at least some embodiments of the present disclosure;

FIG. 9A illustrates a first step in performing a collective operation using four nodes in accordance with at least some embodiments of the present disclosure;

FIG. 9B illustrates a second step in performing a collective operation using four nodes in accordance with at least some embodiments of the present disclosure;

FIG. 9C illustrates a third step in performing a collective operation using four nodes in accordance with at least some embodiments of the present disclosure;

FIG. 9D illustrates a fourth step in performing a collective operation using four nodes in accordance with at least some embodiments of the present disclosure;

FIG. 9E illustrates a fifth step in performing a collective operation using four nodes in accordance with at least some embodiments of the present disclosure;

FIG. 9F illustrates a sixth step in performing a collective operation using four nodes in accordance with at least some embodiments of the present disclosure; and

FIG. 10 is a flow chart illustrating a method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a Printed Circuit Board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means: A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” and “compute,” and variations thereof, as used herein, are used interchangeably and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

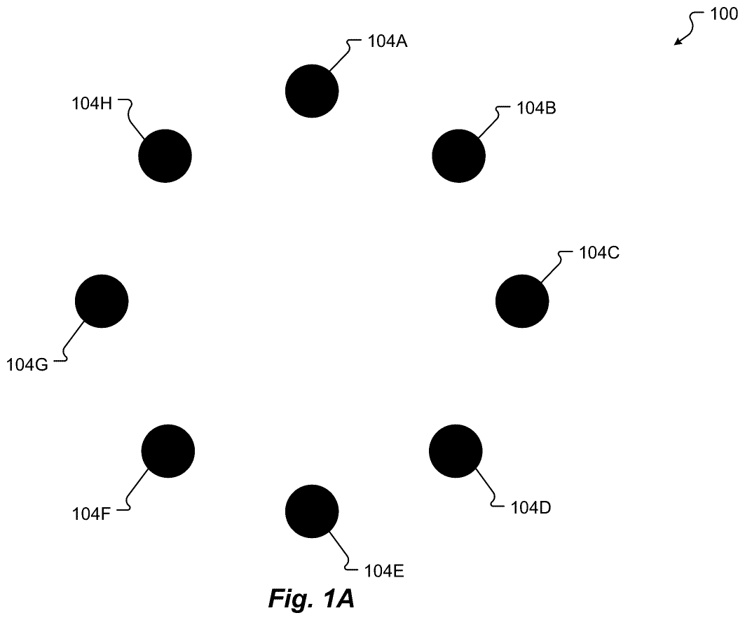

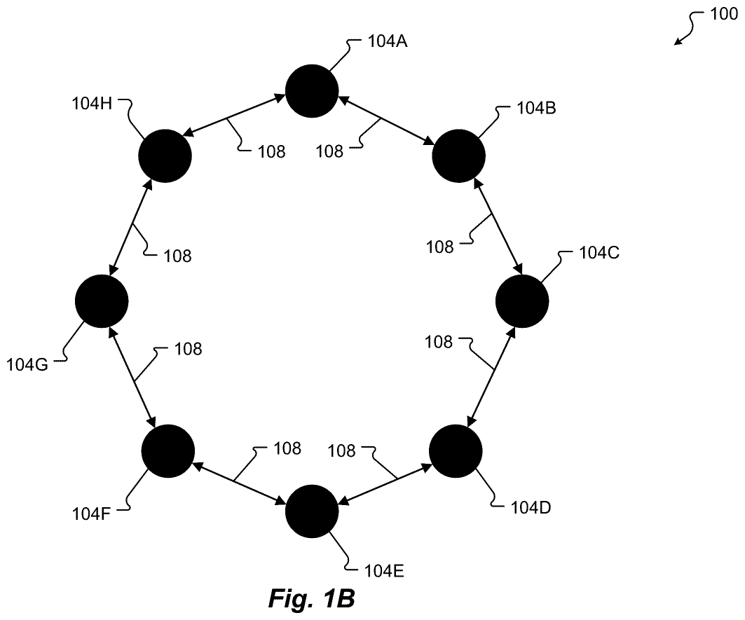

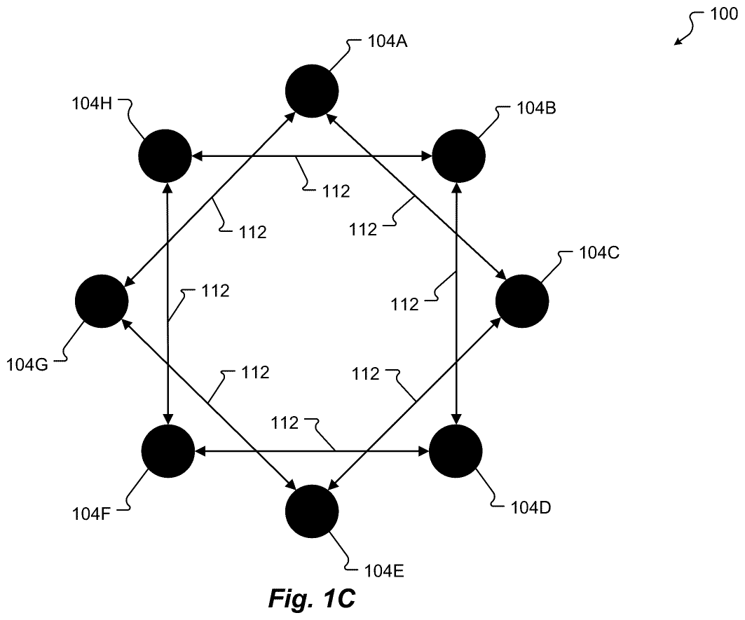

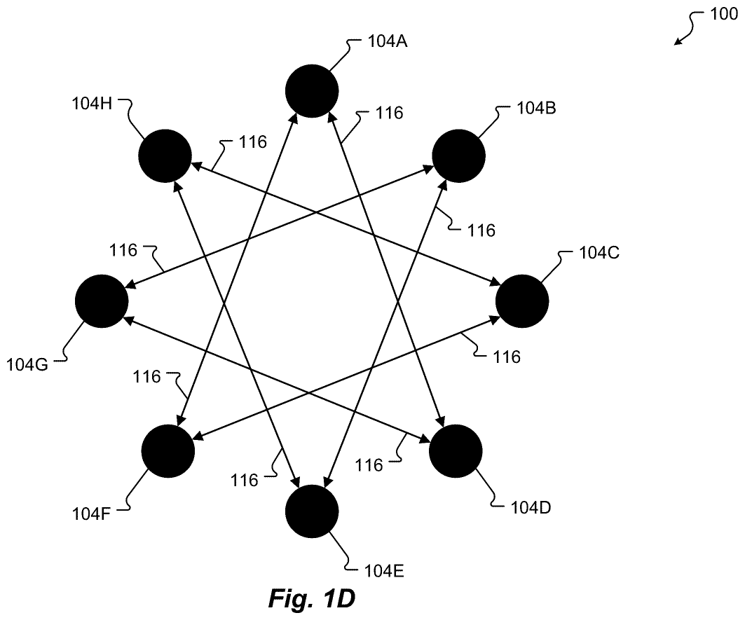

Referring now to FIGS. 1-10, various systems and methods for performing collective operations will be described in accordance with at least some embodiments of the present disclosure. While embodiments will be described in connection with particular operations (e.g., Allreduce, Iallreduce, Alltoall, Ialltoall, Alltoallv, Ialltoallv, Allgather, Scatter, Reduce, and/or Broadcast), it should be appreciated that the concepts and features described herein can be applied to any number of operations. Indeed, the features described herein should not be construed as being limited to the particular types of collective operations depicted and described.

While concepts will be described herein with respect to offloading computational and/or communication tasks associated with an Allreduce collective operation, it should be appreciated that the claims are not so limited. For example, embodiments of the present disclosure aim to improve performance of any operation that includes different types of tasks (e.g., application-level tasks, computational tasks, communication tasks, etc.). Thus, embodiments of the present disclosure may be applicable to offloading any type of task for any type of operation. The description of processors, network-attached co-processors, and the like for the purposes of improving the efficiency of a collective operation are for illustrative purposes only.

Advantageously, embodiments of the present disclosure may enable true asynchronous progress of the collective operation from the host process. Once the operation is posted, further CPU progress can be avoided to complete the operation and can support posting any number of operations to the DPU. This may also help ensure that some or all posted tasks (e.g., Allreduce tasks) will be progressed asynchronously by the DPU.

Referring initially to FIG. 1A, an illustrative system 100 is shown in which members/processes/endpoints are organized into a collective. The collective shown in FIG. 1 includes multiple endpoints 104 (e.g., network elements or other devices) that all contribute computing resources (e.g., processing resources and/or memory resources) to the collective. For example, the system 100 may include a first endpoint 104A, a second endpoint 104B, a third endpoint 104C, a fourth endpoint 104D, a fifth endpoint 104E, a sixth endpoint 104F, a seventh endpoint 104G, and an eight endpoint 104H, that form the collective and contribute computing resources to the collective. While eight (8) endpoints 104 are included in the example of the collective illustrated in FIGS. 1A-1D, the collective (and corresponding techniques described herein) may include any number of endpoints 104 (e.g., greater than or less than eight (8) endpoints).

In some embodiments, the system 100 and corresponding collective formed by the multiple endpoints 104 may represent a ring network topology, ring algorithm, ring exchange algorithm, etc. A ring algorithm may be used in a variety of algorithms and, in particular, for collective data exchange algorithms (e.g., such as MPI_alltoall, MPI_alltoallv, MPI_allreduce, MPI reduce, MPI_barrier, other algorithms, OpenSHMEM algorithms, etc.).

Additionally or alternatively, while FIGS. 1A-1D and the techniques will be described in the example of a ring network topology or ring algorithm, the system 100 and corresponding collective may use any data exchange pattern that corresponds to a global communication pattern that implements algorithms that are collective in nature (e.g., all endpoints in a well-defined set of end-points participate in the collective operation). For example, the system 100 may comprise an ordered list of communication endpoints (e.g., the endpoints 104 are logically arranged in a structured order or pattern), where each endpoint 104 in the collective sends data to each other endpoint 104 (e.g., the data may be zero (0) bytes) and where each endpoint 104 in the collective receives data from each other endpoint 104 (e.g., the data may be zero (0) bytes). In some examples, the data exchange pattern and/or global communication pattern implemented by the collective may be referred to as an all-to-all communication pattern. As a more specific, but non-limiting example, the collective may be organized into a tree or hierarchical structure and results computed at one network element may be communicated up the tree to another network element.

The hierarchical tree may include a network element designated as a root node, one or more network elements designated as vertex nodes, one or more network elements designated as leaf nodes. In some embodiments, the topology(ies) employed may not necessarily require a subnet manager. Embodiments of the present disclosure may provide an endpoint offload, and may be used with any suitable network fabric that supports an intelligent NIC as an endpoint (e.g., RoCE, HPE slingshot RoCE, etc.).

All endpoints 104 of the collective may follow a fixed data exchange pattern of data exchange. In some examples, communication among the collective may be initiated with a subset of the endpoints 104. Accordingly, a fixed global pattern may be followed to ensure that one endpoint 104 will not reach a deadlock, and the data exchange is guaranteed to complete (e.g., barring system failures).

In the example of FIG. 1A, each endpoint 104 may be labeled (e.g., to represent their order in the collective and the fixed data exchange pattern). Additionally, each endpoint 104 may begin the collective by sending and receiving messages to themselves (e.g., each endpoint, Pi, sends and receives messages to/from Pi+0 and Pi−0). In the example of FIG. 1B, each endpoint 104 may participate in a data exchange 108 with a next ordered endpoint 104 in the collective. For example, each endpoint, Pi, may post a send message to a next ordered endpoint, Pi+1, and each endpoint, Pi, may post a receive message to a preceding ordered endpoint, Pi−1. As an illustrative example, the first endpoint 104A (e.g., P1) may post a send message to the second endpoint 104B (e.g., P2) and may post a receive message to the eight endpoint 104H (e.g., P8) with wrap-around.

In the example of FIG. 1C, each endpoint 104 may participate in a data exchange 112 with a next ordered endpoint 104 in the collective, where the next ordered endpoint 104 is next in the collective and corresponding fixed data exchange pattern relative to the endpoint 104 of the data exchange 108 as described with reference to FIG. 1B. For example, each endpoint, Pi, may post a send message to a next ordered endpoint, Pi+2, and each endpoint, Pi, may post a receive message to a preceding ordered endpoint, Pi−2. As an illustrative example, the first endpoint 104A (e.g., P1) may post a send message to the third endpoint 104C (e.g., P3) and may post a receive message to the seventh endpoint 104G (e.g., P7) with wrap-around.

In the example of FIG. 1D, each endpoint 104 may participate in a data exchange 116 with a next ordered endpoint 104 in the collective, where the next ordered endpoint 104 is next in the collective and corresponding fixed data exchange pattern relative to the endpoint 104 of the data exchange 112 as described with reference to FIG. 1C. For example, each endpoint, Pi, may post a send message to a next ordered endpoint, Pi+3, and each endpoint, Pi, may post a receive message to a preceding ordered endpoint, Pi−3. As an illustrative example, the first endpoint 104A (e.g., P1) may post a send message to the fourth endpoint 104D (e.g., P4) and may post a receive message to the sixth endpoint 104F (e.g., P6) with wrap-around.

In some embodiments, the internal data exchange described in the example of FIG. 1A and the data exchanges 108, 112, and 116 may occur simultaneously or nearly simultaneously. Additionally or alternatively, a subset of the data exchanges may occur simultaneously or nearly simultaneously. Additionally or alternatively, the data exchanges may occur separately or independently. For example, Ns and Nr may dictate a number of data exchanges the endpoints 104 are capable of performing at a time. If Nr and Ns are equal to one (1) (e.g., each endpoint 104 can send/receive one message at a time), each of the data exchanges illustrated in the examples of FIGS. 1A, 1B, 1C, and 1D may occur consecutively (e.g., each data exchange is not performed until the preceding data exchange is completed).

As data is aggregated and forwarded (e.g., up the tree, around the ring, etc.), the data will eventually reach a destination node. The destination node may collect or aggregate data from other nodes in the collective and then distribute a final output. For instance, a root node may be responsible for distributing data to one or more specified SHARP tree destinations per the SHARP specification. In some embodiments, data is delivered to a host in any number of ways. As one example, data is delivered to a next work request in a receive queue, per InfiniBand transport specifications. As another example, data is delivered to a predefined (e.g., defined at operation initialization) buffer, concatenating the data to that data which has already been delivered to the buffer. A counting completion queue entry may then be used to increment the completion count, with a sentinel set when the operation is fully complete.

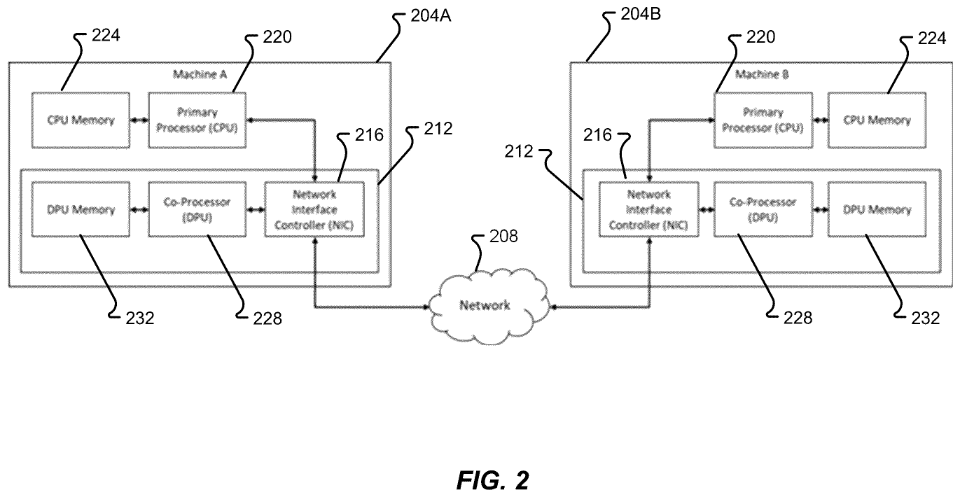

Referring now to FIG. 2, additional details of devices that may be used within a collective will be described in accordance with at least some embodiments of the present disclosure. FIG. 2 illustrates two machines 204A, 204b that communicate with one another via a communication network 208. Each machine 204a, 204b may be connected with the network 208 via an interface device 212. The interface device 212 may correspond to a networking card, network adapter, or the like that enables physical and logical connectivity with the network 208. In some embodiments, the interface device 212 includes a Network Interface Controller (NIC) 216, a processor 228, and memory 232. Each machine 204a, 204b is also illustrated to include a primary processor 220 and memory 224. The primary processor 220 and memory 224 may correspond to a primary or main processing unit of the machine 204a, 204b that performs traditional tasks for the machine 204a, 204b. In some embodiments, the primary processor 220 may correspond to a Central Processing Unit (CPU) or collection of CPUs. The primary processor 220 may also correspond to or include a Graphics Processing Unit (GPU) or other type of processor. As will be described in further detail herein, the primary processor 220 may coordinate with the processor 228 of the interface device 212. In some embodiments, the secondary processor or co-processor 228 may correspond to a Data Processing Unit (DPU) or the like.

The primary processor 220 may independently utilize the primary processor memory 224 while the co-processor 228 may independently utilize the co-processor memory 232. In some embodiments, the primary processor 220 may access contents of the co-processor memory 232 only via the co-processor 228. Similarly, the co-processor 228 may only be capable of accessing the primary processor memory 224 via the primary processor 220. Additional details of such memory-accessing techniques will be described in further detail below.

In some embodiments, the primary processor 220 may be configured to offload at least some computational and/or communication tasks to the processor 228 of the interface device 212. The processor 228 may correspond to co-processor of the machine 204a, 204b, meaning that the processor 228 is subordinate or responsive to instructions issued by the primary processor 220. The memory 232 of the interface device 212 may be leveraged by the co-processor 228 when performing communication and/or computational tasks whereas memory 224 may be leveraged by the primary processor 220 when performing application-level tasks (e.g., or other tasks not offloaded by the primary processor 220). In some embodiments, the primary processor 220 may be responsible for qualifying the machine 204a, 204b for inclusion in a collective. For instance, the primary processor 220 may respond to an invitation to join a collective and perform other tasks associated with initializing processing of the collective operation. In some embodiments, the primary processor 220 may disqualify itself if a connection to the co-processor cannot be established.

In some embodiments, the primary processor 220 is connected to the co-processor 228 through the NIC 216. In some embodiments, the primary processor 220 may be network-attached with the co-processor 228 via the NIC 216. As a non-limiting example, the NIC 216 may be capable of supporting Remote Direct Memory Access (RDMA) such that the primary processor 220 and network-attached co-processor 228 communicate with one another using RDMA communication techniques or protocols. In some embodiments, the primary processor 220 and co-processor 228 may register their respective memory 224, 232 with the NIC 216 before then can be used in communication. During an initialization phase, the primary processor 220 and the co-processor 228 may exchange a set of memory addresses and associated keys for sending and receiving control messages (e.g., for exchanging RDMA messages with one another).

The primary processor 220 may signal the co-processor 228 to begin execution of tasks as part of completing a collective operation. In some embodiments, the primary processor 220 may provide the co-processor 228 with metadata that enables the co-processor 228 to complete computational and/or communication tasks as part of the collective operation. Once computational and/or communication tasks have been offloaded to the co-processor 228, the primary processor 220 may way for a completion signal from the co-processor 228 indicating that the co-processor 228 has completed the delegated communication and/or computational tasks. In this way, the co-processor 228 may be viewed as a complementary service that is launched separately from a main job being performed by the primary processor 220. The co-processor 228 may open a communication socket (e.g., via the NIC 216) and wait for a connection from the primary processor 220. In some embodiments, the co-processor 228 may service specific tasks for a collective operations delegated thereto by the primary processor 220 and then signal the primary processor 220 when such tasks have been completed.

The machine 204a, 204b may utilize the NIC 216 to connect with the communication network 208 via a communication link. The communication link may include a wired connection, a wireless connection, an electrical connection, etc. In some embodiments, the communication link may facilitate the transmission of data packets between the other devices connected to the network 208. Other members of a collective (e.g., network elements 104, machines 204, etc.) may also be connected to the network 208. It should be appreciated that the communication link established between the interface device 212 and the network 208 may include, without limitation, a PCIe link, a Compute Express Link (CXL) link, a high-speed direct GPU-to-GPU link (e.g., an NVlink), etc.

One or both memory devices 224, 232 may include instructions for execution by their processor (or co-processor) that, when executed by the processor (or co-processor), enable the processing unit to perform any number of tasks. The types of tasks that may be performed in the primary processor 220 or may be offloaded to the co-processor 228 include, without limitation, application-level tasks (e.g., processing tasks associated with an application-level command, communication tasks associated with an application-level command, computational tasks associated with an application-level command, etc.), communication tasks such (e.g., data routing tasks, data sending tasks, data receiving tasks, etc.), and computational tasks (e.g., Boolean operations, arithmetic tasks, data reformatting tasks, aggregation tasks, reduction tasks, get tasks, etc.). Alternatively or additionally, the processing unit(s) 220, 228 may utilize one or more circuits to implement functionality of the processor described herein. In some embodiments, processing circuit(s) may be employed to receive and process data as part of the collective operation. Processes that may be performed by processing circuit(s) include, without limitation, arithmetic operations, data reformatting operations, Boolean operations, etc.

The primary processor 220 and/or co-processor 228 may include one or more Integrated Circuit (IC) chips, microprocessors, circuit boards, simple analog circuit components (e.g., resistors, capacitors, inductors, etc.), digital circuit components (e.g., transistors, logic gates, etc.), registers, Field Programmable Gate Arrays (FPGAs), Application Specific Integrated Circuits (ASICs), combinations thereof, and the like. As noted above, the primary processor 220 and/or co-processor 228 may correspond to a CPU, GPU, DPU, combinations thereof, and the like. Thus, while two discrete processors (e.g., a primary processor 220 and co-processor 228) are depicted as being included in a machine 204a, 204b, it should be appreciated that the machine 204a, 204b may include three, four, or more processors or processing units without departing from the scope of the present disclosure.

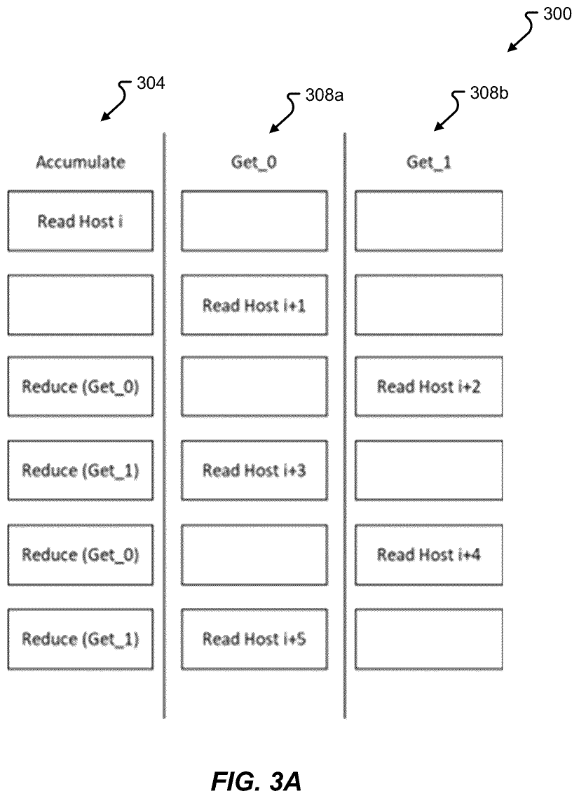

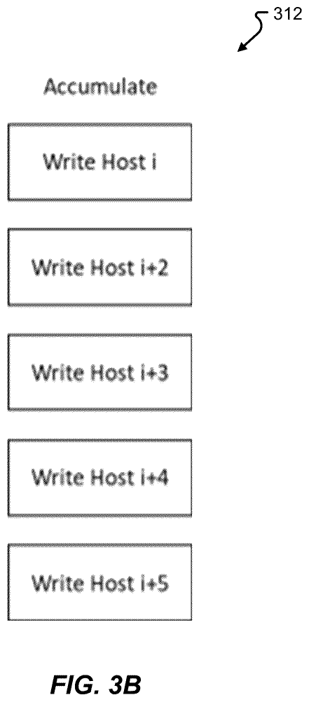

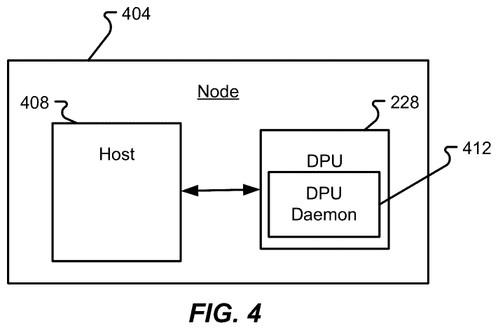

With reference now to FIGS. 3A, 3B, 4, and 5 additional details of the various phases involved in a collective operation will be described in accordance with at least some embodiments of the present disclosure. FIG. 4 illustrates a node 404 having a host 408 and a DPU 228. The host 408 may correspond to an example of a primary processor 220 and the DPU 228 may correspond to an example of a co-processor 228. Thus, it should be appreciated that a node 404 may correspond to an endpoint 104, network element, device, and/or machine 204. As mentioned above, the execution of a collective operation in which at least some tasks are offloaded from a primary processor 220 to a network-attached co-processor 228 may include an initialization phase, a get+reduce phase 300, and a broadcast phase 312.

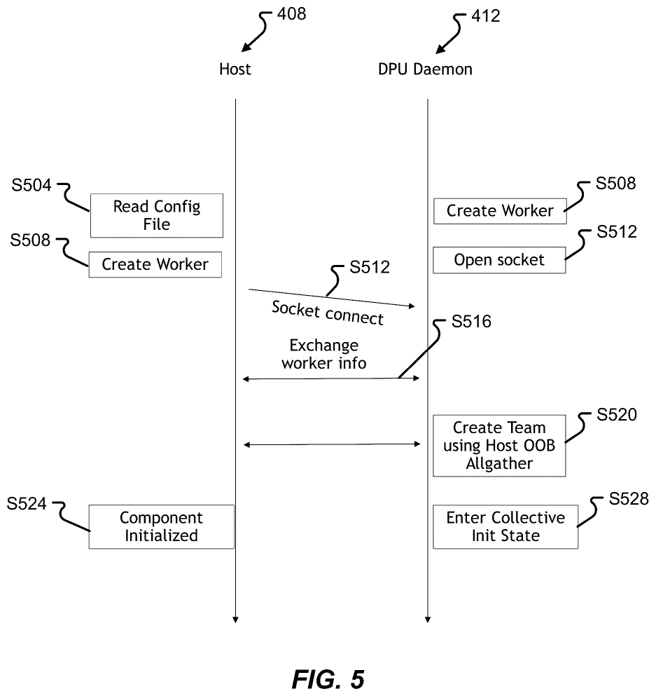

As shown in FIG. 5, in the initializing phase, the host 408 may be responsible for initializing the DPU daemon 412 (e.g., the component of the co-processor or DPU 228). In some embodiments, the host 408 may read a configuration file (step S504) then create a worker node (step S508). The DPU daemon 412 may also create a worker node (step S508) and then open a communication socket (step S512) via the NIC 216. With the socket connection established (step S512), the host 408 may be allowed to exchange worker information with the DPU daemon 412 (step S516). In some embodiments, the host 408 may send information to the DPU daemon 412 that enables the DPU daemon 412 to perform one or more tasks on behalf of the host 408. The information shared from the host 408 to the DPU daemon 412 may include, without limitation, a type of reduction operation, a number of elements, an address of an input vector, and an address of an output vector. It should be appreciated that the address of the output vector may be the same as the address of the input vector, although such a configuration is not required. Said another way, the address of the output vector and the address of the input vector may be the same or may be different, without departing from the scope of the present disclosure.

Once the DPU daemon 412 has received the worker information from the host 408, the DPU daemon 412 may create a collective team using the host 408 Out Of Band (00B) Allgather (step S520). At this point, the host 408 considers the DPU daemon 412 as being initialized (step S524) and the DPU daemon 412 may enter the collective initialization state (step S528). Once the control message has been sent, the host 408 can perform application computation or periodically poll a pre-determined memory location to check for a completion message from the DPU daemon 412. Each instance of the application is identified by an integer ranging from 0 to N−1 where N is the number of instances. The input vector is divided into N chunks and each chunk is assigned to a DPU 228 according to its identifier rank.

FIG. 3A illustrates additional details of a get+reduce phase 300. In this particular phase, each DPU 228 receives the control message and initiates the Allreduce collective independent of each other. Each DPU may allocate (e.g., pre-allocate, dynamically allocate, etc.) buffers in its memory (e.g., at least three buffers) identified as the accumulate buffer 304 and two get buffers 308a, 308b. Using the RDMA capability of the NIC 216, the DPU 228 reads the input vector from its own host 408 into the accumulate buffer 304. In some embodiments, the accumulate buffer 304 and get buffers 308a, 308b may not be large enough to hold all the elements of the input vectors assigned to a DPU 228 by the host 408. In this case only the number of elements that can fit in the buffer are copied at a time. The DPU 228 keeps track of the number of elements read and the offset for subsequent reads.

Each DPU 228 then issues a RDMA read from the input vector of the next logical host into its first get buffer 208a. Once the data is available in the first get buffer 208a, a reduction operation is initiated on the accumulate buffer 304 and the first get buffer 308a and the result is stored in the accumulate buffer 304. This reduction can be performed in parallel on multiple cores of the DPU 228. While the reduction is in progress, the DPU 228 issues another RDMA read from the input vector of the next logical host into the second get buffer 208b. Once the reduction and read operations have been completed, the DPU 228 now reduces the accumulate buffer 304 and the second get buffer 308b into the accumulate buffer 304. The first get buffer 308a is now unused and another RDMA read is issued into it for the next logical host. This process of alternating the buffers is continued until the DPU 228 has received and reduced the assigned elements from each of the participant hosts.

As shown in FIG. 3B, the result of the reduction is now available in the accumulate buffer 304 and a broadcast phase 312 may be performed. Each DPU 228 holds a portion of the output vector. Each DPU 228 may be configured to perform RDMA writes to the address of the output vector at each participant host at the corresponding offset. Once the entire result vector has been broadcasted to the host memory (e.g., memory 224), the DPUs 228 may synchronize to ensure that all the participant DPUs 228 have finished broadcasting their results. Then the DPUs 228 send a message to the host 408 to signal the completion of the Allreduce collective and the application can proceed.

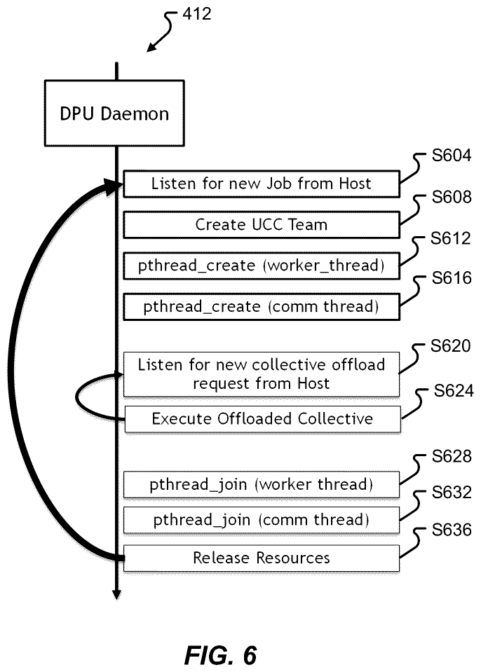

With reference now to FIG. 6, additional details of a DPU daemon 412 workflow will be described in accordance with at least some embodiments of the present disclosure. The DPU daemon 412, once initialized, may be configured to perform a number of different tasks in an effort to offload burdens from the primary processor 220 (e.g., host 408). Specifically, but without limitation, the DPU daemon 412 may be utilized by the DPU 228 to listen for new jobs from the host (step S604). The DPU daemon 412 may also be configured to create a collective team for performing its delegated task(s) (step S608). The team formed by the DPU daemon 412 may be formed using rank, number of ranks, etc. In some embodiments, the DPU daemon 412 may spawn worker threads (step S612). The DPU daemon 412 may then also spawn helper/communication threads to support the worker threads (step S618).

In some embodiments, the worker threads may be responsible for executing offloaded collective tasks (step S624), which may include reducing incoming data, reducing data when signaled by a communication thread, and/or using multiple processing cores within the DPU 228. In some embodiments, the helper/communication threads may listen for incoming signals for executing collectives from the host 408 (step S620), use one-sided semantics to read/write data from host buffers, and/or progress a collective algorithm. As a more specific, but non-limiting example, the DPU daemon 412 may be configured to join other worker threads initiated by other DPUs 228 (step S628), join other communication threads initiated by other DPUs 228 (step S632), and/or release resources of the DPU 228 (step S636).

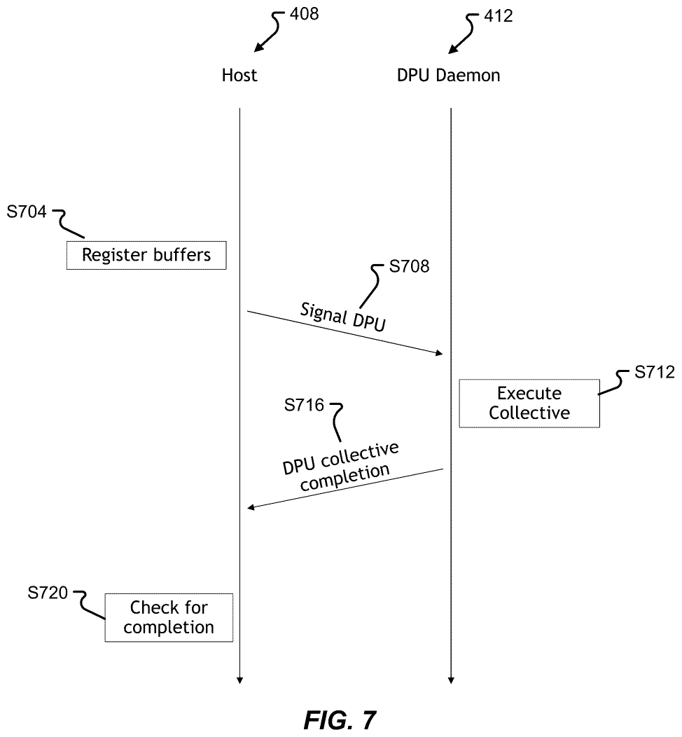

With reference now to FIG. 7, additional details of a buffer registration process will be described in accordance with at least some embodiments of the present disclosure. The process may begin when the host 408 registers one or more buffers (step S704). In this step, the host 408 may register buffers from memory 224 and/or from memory 232. The buffers may correspond to accumulate buffers and/or get buffers. This step may also include the host 408 filling in any metadata needed to facilitate RDMA communications between the host 408 and DPU daemon 412, including registration keys.

The host 408 then signals the DPU 228 (step S708) with instructions to begin executing a collective operation or a portion thereof. The DPU daemon 412 may then respond by executing the collective or the tasks assigned thereto by the host 408 (step S712).

When the DPU 228 or the DPU daemon 412 has completed the delegated tasks, the DPU daemon 412 may signal the host that the DPU collective has completed (step S716). The host 408 will receive or recognize transmission of the signal from the DPU 228 or DPU daemon 412 because the host 408 will have been listening of polling for a complete signal. In other words, the host 408 may actively check for completion of the DPU collective (step S720).

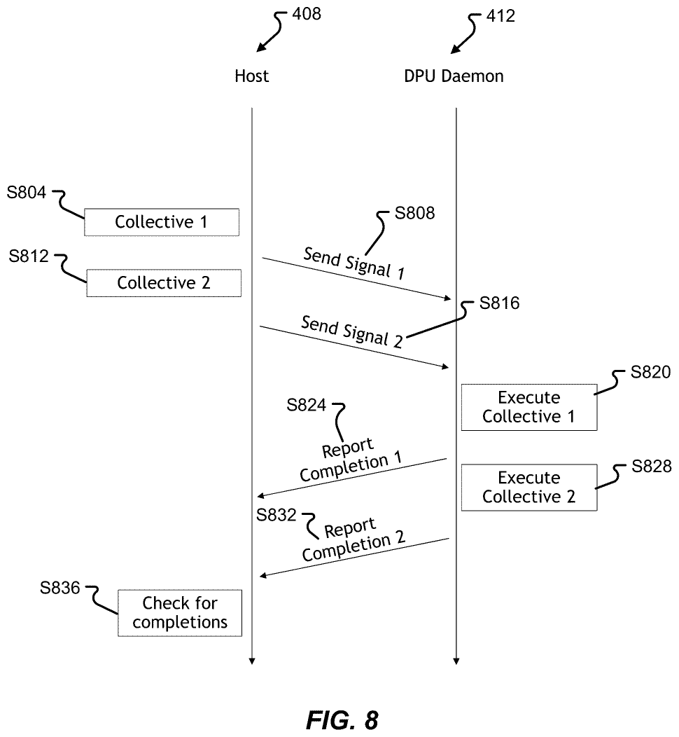

With reference now to FIG. 8, a flow diagram illustrating details of a collective operation will be described in accordance with at least some embodiments of the present disclosure. The operation begins with the host 408 initiating a first collective (step S804) by sending a first collective request to the DPU daemon 412 (step S808). Information needed by the DPU daemon 412 to perform the operation may be included in this initial collective request. As shown in FIG. 8, the host 408 may send multiple requests back-to-back without waiting for completion or confirmation of receive (steps S812 and S816). After one or more requests have been transmitted by the host 408, the host 408 may then poll the DPU daemon 412 asking whether the requested collective operations have been completed (step S836). In some embodiments, the host 408 periodically polls a predetermined memory location to check for a completion message from the DPU daemon 412. It should be appreciated that, in some embodiments, multiple completion messages may be enqueued before being processed.

When the DPU daemon 412 receives the signal(s) from the host 408 initiating the collective operation, the DPU daemon 412 may respond by executing one or more collectives (steps S820 and S828). As each collective operation is completed, the DPU daemon 412 may report completion by sending an appropriate completion signal back to the host 408 via an RDMA signal (steps S824 and S832). In some embodiments, the DPU daemon 412 may execute the collectives one by one based on the order in which the requests were received from the host 408. The DPU daemon 412 may also be configured to re-order the collectives by priority based on priority information contained in the requests. It may also be possible for the DPU daemon 412 to send completion signals for multiple collective operations without requiring the host 408 to call or poll for progress of each collective operation.

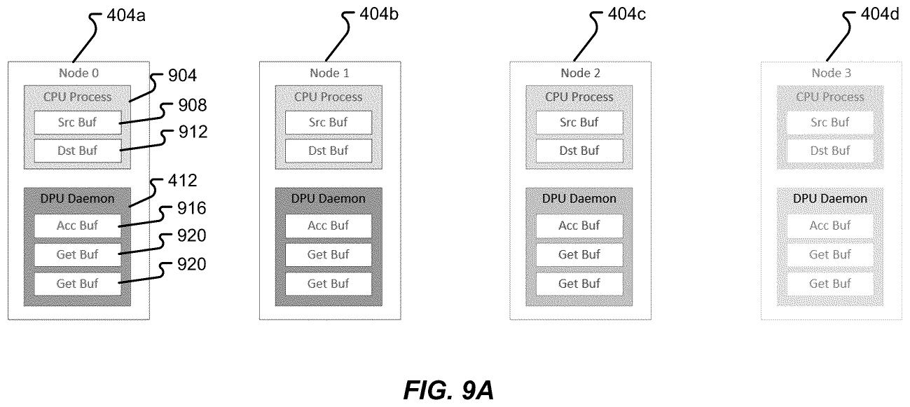

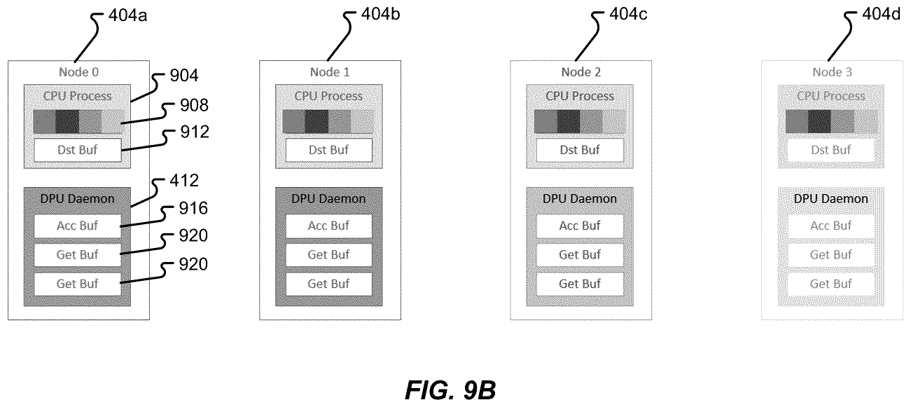

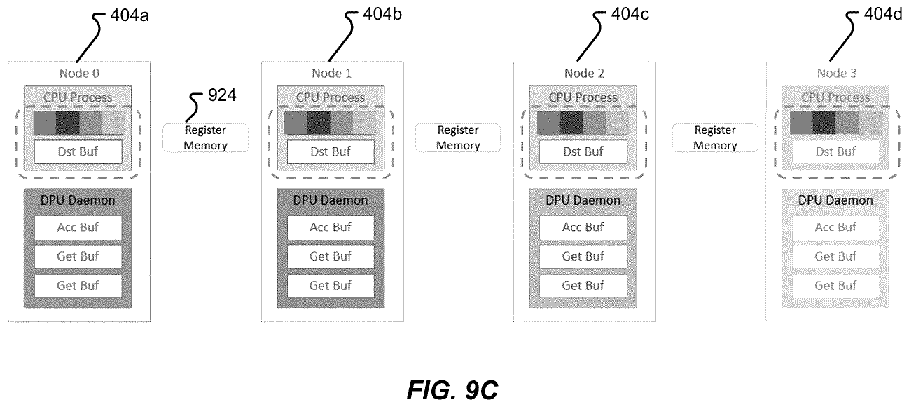

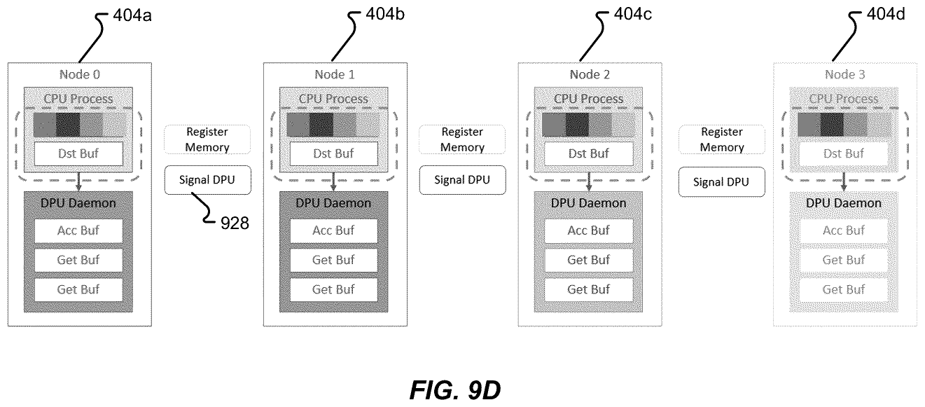

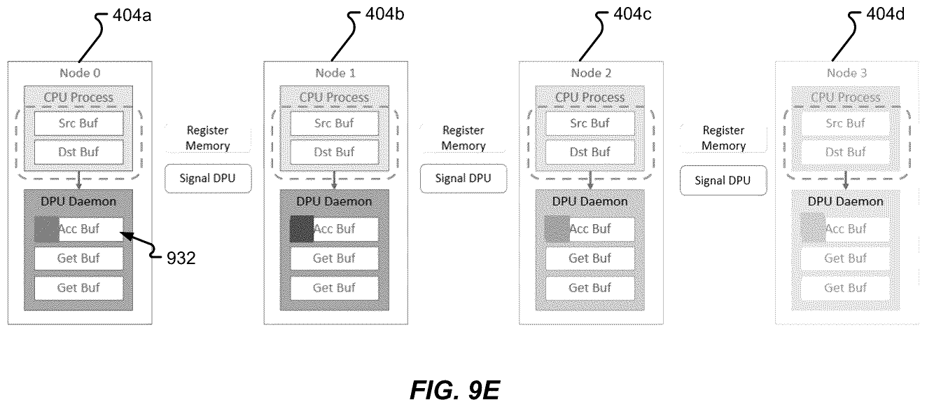

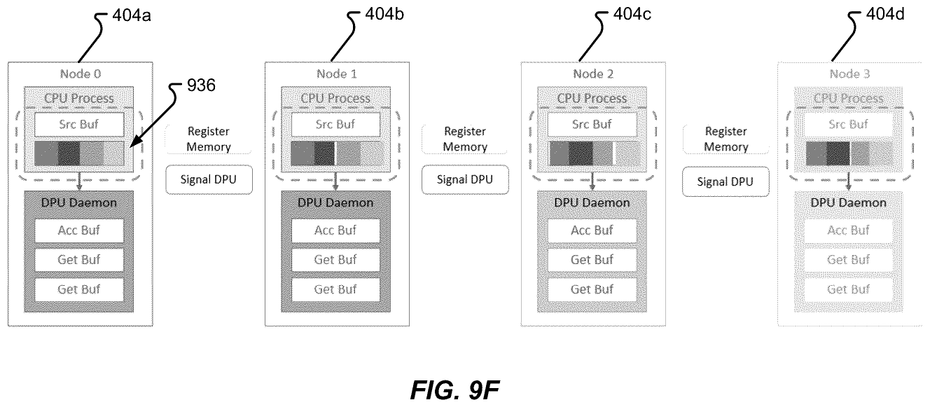

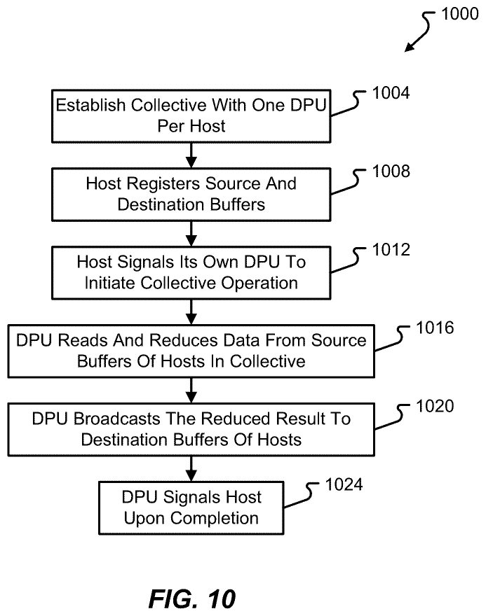

Referring now to FIGS. 9A-10, additional details regarding operations of components in the system 100 will be described. While certain steps of a method 1000 will be described as being performed in a particular order and by a particular component, it should be appreciated that embodiments of the present disclosure are not so limited. Specifically, the order of operations in the various methods may be modified and any component or combination of components in the system 100 may be configured to perform some or all of the method steps depicted and described herein.

FIG. 9A illustrates the system having four compute nodes 404a-d. Each node 404a-d may also be part of a machine, such as machine 204a and/or 204b. Each node 404a-d is shown to include its own host 408. The host 408 of each node 404a-d may also be referred to as a CPU process 904 without departing from the scope of the present disclosure. The host 408 or CPU process 904 may include a source buffer 908 and a destination buffer 912. As a more specific but non-limiting example, each host 408 or CPU process 904 may allocate a source buffer 908 and destination buffer 912 from a memory device, such as CPU memory 224.

Each node 404a-d is also shown to include a DPU daemon 412, which may be part of a DPU 228. The DPU 228 and/or DPU daemon 412 may correspond to examples of a network-attached co-processor 228 as shown and described in connection with FIG. 2. The DPU daemon 412 may include an accumulate buffer 916 and one or more get buffers 920. The accumulate buffer 916 may be similar or identical to the accumulate buffer 304 and the one or more get buffers 920 may be similar or identical to the get buffers 308a, 308b shown and described in connection with FIGS. 3A and 3B. The system of FIG. 9A illustrates four hosts 408 or CPU processes 904, each having one DPU 228 per host 408. In some embodiments, each DPU 228 or DPU daemon 412 of a compute node 404 may be responsible for reducing a portion of a vector. The method 1000 begins with the nodes 404 establishing a collective for purposes of performing an operation (step 1004). As mentioned above, the collective may be established with one DPU 228 per host 408.

The method 1000 continues with each host 408 registering 924 its source buffer 908 and destination buffer 912 with each DPU 228 (step 1008). The memory registration process is illustrated in FIGS. 9B and 9C. In some embodiments, different portions of a source buffer 908 and memory buffer 912 may be allocated to a different DPU 228. For example, the first host 408 (also shown as a CPU process 904 of the first node 404a) may register 924 a first portion of its source buffer 908 to the DPU 228 of the first node 404a, a second portion of its source buffer 908 to the DPU 228 of the second node 404b, a third portion of its source buffer 908 to the DPU 228 of the third node 404c, and a fourth portion of its source buffer 908 to the DPU 228 of the fourth node 404d. A similar approach may be followed by the hosts 408 of the other nodes 404b-d. Likewise, each host 408 of each node 404a-d may register 924 different portions of their destination buffer 912 to DPUs 228 of different nodes 404a-d. For instance, the first host 408 may register a first portion of its destination buffer 912 to the DPU 228 of the first node 404a, a second portion of its destination buffer 912 to the DPU 228 of the second node 404b, a third portion of its destination buffer 912 to the DPU 228 of the third node 404c, and a fourth portion of its destination buffer 912 to the DPU 228 of the fourth node 404d.

Following buffer registration, the method 1000 continues with each host 408 signaling 928 its own DPU to initiate the collective operation (step 1012). The DPU signaling process is illustrated in FIG. 9D. In some embodiments, each host 408 may provide information to its DPU 228 that allows the DPU 228 to perform a portion of a collective task. As discussed above, the DPU 228 may have computational and/or communication tasks delegated thereto by the host 408. In some embodiments, the DPU signaling may include information that allows each DPU 228 to begin executing its portion of the collective (e.g., a data vector, part of a data vector, etc.).

In response to receiving an initiation signal from its host 408, each DPU 228 may begin reading and reducing data from the source buffers of each host 408 in the collective (step 1016). In the illustrated example, the DPU 228 of the first node 404a may first read data from the source buffer 908 of the host 408 in the first node 404a. The data read from the first host 408 may be stored in the first get buffer 920. Data from the first get buffer 920 may be moved into the accumulate buffer 916 while the DPU 228 of the first host 440a reads data from the source buffer 908 of the host 408 in the second node 404b. The data read from the second host 408 may be stored in the second get buffer 920 before, simultaneous with, or after the data from the first get buffer 920 is moved to the accumulate buffer 916. Data from the second get buffer 920 may be moved to the accumulate buffer 916 where it is accumulated and/or reduced with the data from the first host 408. Data from the second get buffer 920 may be moved into the accumulate buffer 916 while the DPU 228 of the first node 404a reads data from the source buffer 908 of the host 408 in the third node 404c. The data read from the third host 408 may be stored in the first get buffer 920 before, simultaneous with, or after the data from the second get buffer 920 is moved to the accumulate buffer 916. Data from the first get buffer (received from the third host 408) may be moved to the accumulate buffer 916 where it is accumulated and/or reduced with data from the first and second hosts 408. Data from the first get buffer 920 may be moved into the accumulate buffer 916 while the DPU 228 of the first node 404a reads data from the source buffer 908 of the host 408 in the fourth node 404d. The data read from the fourth host 408 may be stored in the second get buffer 920 before, simultaneous with, or after the data from the first get buffer 920 is moved to the accumulate buffer 916. Data from the second get buffer (received from the fourth host 408) may be moved to the accumulate buffer 916 where it is accumulated and/or reduced with data from the other hosts 408.

Once all data has been accumulated and/or reduced by the DPUs 228 of the collective (e.g., as shown in FIG. 9E), the data may be moved from the accumulate buffer 920 of each DPU 228 into the destination buffers 912 of the hosts (e.g., as shown in FIG. 9F). Specifically, the method 1000 may continue with each DPU broadcasting the reduced results stored in its accumulate buffer 916 back to the destination buffers 912 of the hosts 408 in the collective (step 1020). As an example, each DPU 228 may broadcast the results stored in the accumulate buffer 916 to every host 408 of every node 404a-d. As another example, each DPU 228 may independently send each host 408 of each node 404a-d the results stored in its accumulate buffer 916. Each DPU 228 may also signal one or more hosts 408 indicating completion of the task(s) delegated thereto by the hosts 408 (step 1024). In some embodiments, each DPU 228 may signal the host 408 of the same node 404. In some embodiments, each DPU 228 may signal all hosts 408 in the collective. Upon completion of the collective operation, the method 1000 may end or return back to step 1004.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A device, comprising:
a network interconnect;
a first processing unit to perform application-level processing tasks; and
a second processing unit in communication with the first processing unit via the network interconnect, wherein the first processing unit is to offload at least one of computation tasks and communication tasks to the second processing unit while the first processing unit performs the application-level processing tasks, and wherein the second processing unit is to provide a result vector to the first processing unit when the at least one of computation tasks and communication tasks are completed.

2. The device of claim 1, wherein the network interconnect comprises a Remote Direct Memory Access (RDMA)-capable Network Interface Controller (NIC) and wherein the first processing unit and second processing unit communicate with one another using RDMA capabilities of the RDMA-capable NIC.

3. The device of claim 1, wherein the first processing unit comprises a primary processor and wherein the second processing unit comprises a network-attached co-processor.

4. The device of claim 3, wherein the primary processor comprises a Central Processing Unit (CPU) that utilizes a CPU memory as part of performing the application-level processing tasks and wherein the network-attached co-processor comprises a Data Processing Unit (DPU) that utilizes a DPU memory as part of performing the at least one of computation tasks and communications tasks.

5. The device of claim 4, wherein the DPU is to receive a control message from the CPU and in response thereto allocate at least one buffer from the DPU memory to perform the at least one of computation tasks and communication tasks.

6. The device of claim 4, wherein the DPU is to perform the at least one of computation tasks and communication tasks as part of an Allreduce collective.

7. The device of claim 4, wherein the CPU memory and the DPU memory are to register with the network interconnect before communications between the CPU and DPU are enabled via the network interconnect.

8. The device of claim 7, wherein the CPU and the DPU are to exchange a set of memory addresses and associated keys for sending and receiving control messages via the network interconnect.

9. The device of claim 1, wherein the first processing unit is to send a control message to the second processing unit to initialize the second processing unit and initiate a reduction operation, wherein the control message is to identify at least one of a type of reduction operation, a number of elements, an address of an input vector, and an address of an output vector.

10. The device of claim 1, wherein the first processing unit is to periodically poll a predetermined memory location to check for a completion message from the second processing unit.

11. The device of claim 1, wherein the second processing unit is to compute a result of at least a portion of a reduction operation, maintain the result in an accumulate buffer, and broadcast the result to the first processing unit.

12. The device of claim 11, wherein the second processing unit is to broadcast the result to a processing unit of another device in addition to broadcasting the result to the first processing unit.

13. The device of claim 1, wherein the application-level processing tasks and the at least one of computation tasks and communication tasks are performed as part of an Allreduce collective operation.

14. A system, comprising:
an endpoint that belongs to a collective, wherein the endpoint is to perform application-level tasks for a collective operation in parallel with one or both of computation tasks and communication tasks for the collective operation.

15. The system of claim 14, wherein the collective operation comprises an Allreduce collective, wherein the application-level tasks are to be performed on a first processing unit of the endpoint, and wherein the one or both of computation tasks and communication tasks are to be offloaded by the first processing unit to a second processing unit of the endpoint.

16. The system of claim 15, wherein the first processing unit is network connected to the second processing unit, wherein the first processing unit is to utilize a first memory device of the endpoint, and wherein the second processing unit is to utilize a second memory device of the endpoint.

17. The system of claim 16, wherein the first processing unit is to communicate with the second processing unit using a Remote Direct Memory Access (RDMA)-capable Network Interface Controller (NIC).

18. The system of claim 14, further comprising:
a second endpoint that also belongs to the collective, wherein the second endpoint also is to perform application-level tasks for the collective operation in parallel with one or both of computation tasks and communication tasks for the collective operation.

19. An endpoint, comprising:
a host; and
a Data Processing Unit (DPU) that is network-connected with the host, wherein the DPU comprises a DPU daemon that is to coordinate a collective offload with the host through a network interconnect and service a collective operation on behalf of the host.

20. The endpoint of claim 19, wherein the DPU daemon is to assume full control over the collective operation after receiving an initialization signal from the host.

21. The endpoint of claim 19, wherein the DPU daemon is to broadcast results of the collective operation to the host and to hosts of other endpoints belonging to a collective.

22. The endpoint of claim 19, wherein the collective operation comprises at least one of Allreduce, Iallreduce, Alltoall, Ialltoall, Alltoallv, Ialltoallv, Allgather, Scatter, Reduce, and Broadcast.
